(19) United States
(12) Patent Application Publication
(10) Pub. No.: US 2024/0243389 A1
(43) Pub. Date: Jul. 18, 2024

(54) Electrical Energy Storage Device

(71) Applicant: Mercedes-Benz Group AG, Stuttgart (DE)

(72) Inventors: Benedikt FRIESS, Leonberg (DE); Harry DOERING, Elchingen (DE); Marius BAUER, Ulm (DE); Daniel BECHER, Ehningen (DE); Olaf BOESE, Ulm (DE)

(21) Appl. No.: 18/558,865

(22) PCT Filed: Apr. 27, 2022
(86) PCT No.: PCT/EP2022/061153

§ 371 Date: Nov. 3, 2023

(30) Foreign Application Priority Data
May 5, 2021 (DE) 10 2021 002 378.1

(51) Int. Cl. H01M 10/658; H01M 50/209; H01M 50/293

(52) U.S. Cl. CPC H01M 10/658; H01M 50/209; H01M 50/293

(57) ABSTRACT

An electrical energy storage device includes a plurality of individual cells that are electrically connected with one another in series and/or in parallel and a plurality of thermal barrier elements that are each respectively disposed between two individual cells of the plurality of individual cells. Each of the plurality of thermal barrier elements has one or two compressible outer layers and an incompressible layer disposed next to the one compressible outer layer or between the two compressible outer layers.

### BACKGROUND AND SUMMARY OF THE INVENTION

The invention relates to an electrical energy storage device having a plurality of individual cells that are electrically connected with one another in series and/or in parallel and a plurality of thermal barrier elements that are arranged between at least two individual cells for reducing the risk of spread of a thermal runaway from a faulty individual cell to at least one neighboring individual cell.

A hydrophilic polymer thermal barrier system is known from US 2014/0224465 A1 for preventing a thermal runaway from spreading from a faulty individual cell to a non-faulty individual cell in a cell assembly of an electrical energy storage device. The hydrophilic polymer thermal barrier system comprises a thermal barrier that is arranged between each of the individual cells and optionally between the individual cells and the housing of the electrical energy storage device. A cross-sectional surface area of the thermal barrier is at least equal to a neighboring individual cell. The thermal barrier contains a heat absorption material in a sufficient quantity to absorb the heat emitted by a faulty individual cell.

In addition, WO 2010/017169 A1 describes an arrangement for suppressing a thermal runaway in a cell assembly of an electrical energy storage device. For this purpose, packs with hydrated hydrogel are used on physical interfaces between groups of one or more individual cells. The hydrogel diffuses and absorbs the heat energy released by the individual cells when a cell fails. During an extreme overheating of an individual cell, the water stored by the hydrogel undergoes a phase transition and evaporates, whereby comparatively large quantities of heat energy are absorbed and a thermal runaway of a neighboring cell is prevented.

The object of the invention is to specify an electrical energy storage device and a use of the electrical energy storage device.

An electrical energy storage device comprises a plurality of individual cells that are electrically connected with one another in series and/or in parallel and a plurality of thermal barrier elements that are arranged between at least two individual cells for reducing the risk of spread of a thermal runaway from a faulty individual cell to at least one neighboring individual cell. According to the invention, the respective thermal barrier element has one or two compressible outer layers for balancing a change in volume of the respectively neighboring individual cell and an incompressible layer arranged next to the one compressible outer layer or between the two compressible outer layers.

By means of a thermal barrier element designed in such a manner, the safety of the electrical energy storage device with regard to a thermal runaway can be substantially increased. In addition, the thermal barrier element is designed to compensate for changes in volume of the individual cells due to the one or two compressible outer layers for balancing a change in volume of the respective neighboring individual cell, such that no additional tension mat or the like is required. The number of components of the electrical energy storage device can thus be reduced, which reduces a mounting effort and costs can be saved.

The thermal barrier element thus unites the properties of a required compressibility for balancing volume and safety in regard to preventing the spread of the thermal runaway from a faulty individual cell to a neighboring individual cell.

Neighboring individual cells of the electrical energy storage device can be electrically insulated by means of the respective thermal barrier element (however, the electrical insulation can also be implemented by other elements (cell insulation)), whereby it is possible to compensate for a cyclical and irreversible increase of a cell thickness by means of the thermal barrier element, and a danger of a chain reaction in the event of a thermal overheating, and thus in the event of a thermal runaway, of an individual cell can be reduced.

In an embodiment of the thermal barrier element, the incompressible layer comprises a support matrix having a hydrogel as a filler, wherein the incompressible layer is surrounded by a sleeve, and thus a pack. The sleeve can be designed to be impermeable to water vapour and/or impermeable to gas. The filler can be introduced into the support matrix essentially without issue. The filler is characterized in particular by a relatively high specific energy absorption during its breakdown and/or a phase transition and is stable in the long term in a sleeve that is impermeable to water vapour and/or impermeable to gas.

A combination of the support matrix and hydrogel as a thermal barrier leads to relatively effectively limiting an internal temperature of neighboring individual cells to below a critical limit temperature, which is required for a thermal runaway of the neighboring individual cell and further individual cells of the electrical energy storage device. A propagation can thus be substantially prevented and a fault can be limited to an individual cell.

As the incompressible layer is designed as a solid layer, a risk of the filler, and thus of the hydrogel, being discharged even when a force acts mechanically on the incompressible layer can be substantially excluded.

A development of the electrical energy storage device provides that the support matrix is designed as a grid structure and/or honeycomb structure. Thermal properties of the thermal barrier element are determined on the one hand by the grid structure and/or honeycomb structure and on the other hand substantially by the filler.

In the course of the thermal runaway, in particular after endothermic reactions are complete, the grid structure and/or honeycomb structure of the incompressible layer maintain a spacing between the faulty individual cell and a neighboring intact individual cell, such that a transfer of thermal energy from the faulty individual cell to the neighboring individual cell can be minimized. Ambient air in the grid structure and/or the honeycomb structure serves as a thermal insulator in this case.

The sleeve, which surrounds the support matrix with the hydrogel, is designed to be impermeable to gas in one embodiment. The sleeve is impermeable to water vapour and serves as a water vapour barrier, whereby the sleeve is designed to be permanently impermeable to gas, and thus no gas can diffuse through the sleeve.

In a further embodiment, the sleeve is made of polyethylene films, in particular having different thicknesses, and/or coated aluminium foils. By means of the sleeve and a stability of the support matrix, it is achieved that the filler introduced in the support matrix evaporates almost entirely in its corresponding chamber of the grid structure and/or honeycomb structure.

The support matrix is welded into the sleeve with the hydrogel, such that the sleeve is designed to be impermeable to gas and the chambers of the support matrix with the introduced filler are separate from each other. As the sleeve is welded and the sleeve is designed to be impermeable to gas, it can substantially be avoided that the hydrogel, and thus the filler or a water vapour released by the latter, escapes.

In a possible development, the sleeve has an intended breaking point, such that the sleeve, i.e., the pack, can be opened as required. For example, the sleeve can be opened by means of the intended breaking point to fill an additional or alternative filler into the chambers.

In a further embodiment of the thermal barrier element, the respective outer layer comprises a polyurethane foam that is adhered to the incompressible layer. The polyurethane foam is selected such that the latter deforms elastically to compensate for a cell thickness growth, for example caused by ageing. A change in volume of the respective individual cell depending on state of charge can be balanced by means of the outer layers. By means of the elastically deformable outer layers comprising the polyurethane foam, an even distribution of pressure to neighboring individual cells is possible, whereby an accelerated ageing can be substantially avoided due to a localized loading of the individual cell.

As an alternative or in addition, the incomprehensible layer can be coated with tension mats and/or foamable materials to form the outer layers. The materials can be foamable silicones, foamable polyurethane materials, polyethylene terephthalate fleeces, foam rubber, polyethylene foams and/or the like.

In a further possible embodiment of the thermal barrier element, a heat-conductive intermediate layer is furthermore arranged between at least one outer layer and the incompressible layer. In particular, the heat-conductive intermediate layer is made of a comparatively stable material, such that it can substantially be prevented that a compressible material of the respective outer layer is pressed into the incompressible layer. For example, the heat-conductive layer is made of glass, carbon fibre sheets and/or carbon fibre films.

Exemplary embodiments of the invention are explained in more detail in the following with reference to the drawings.

### BRIEF DESCRIPTION OF THE DRAWINGS

FIG. 1 schematically shows a sectional depiction of a thermal barrier element for an electrical energy storage device comprising a plurality of individual cells; and

FIG. 2 schematically shows a perspectival exploded depiction of a section of an electrical energy storage device having individual cells and thermal barrier elements.

### DETAILED DESCRIPTION OF THE DRAWINGS

Parts corresponding to one another are provided with the same reference numerals in all figures.

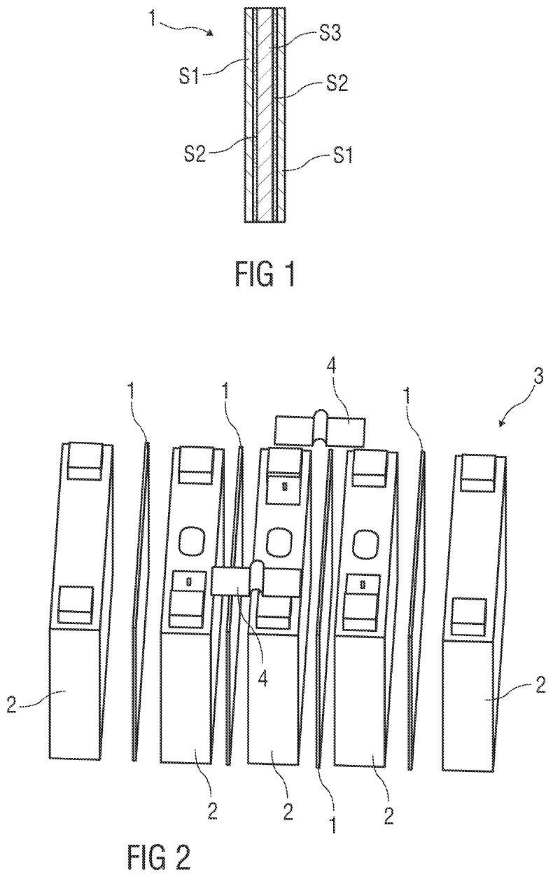

FIG. 1 shows a sectional depiction of a thermal barrier element 1 depicted in a significantly simplified manner for an electrical energy storage device 3 comprising a plurality of individual cells 2 that is partially shown in a perspectival exploded depiction in FIG. 2.

The electrical energy storage device 3 can, for example, be a traction battery for an electric vehicle, a hybrid vehicle or a vehicle operated with fuel cells, or a home storage battery, power tools, backup batteries, industrial storage devices, etc.

The individual cells 2 are in particular lithium-ion individual cells and connected to each other electrically in series and/or in parallel by means of so-called cell connectors 4.

Due to a faulty individual cell 2, an uncontrolled energy release can arise in this individual cell 2 in some circumstances. A consequence of a comparatively high packing density in cell modules of the electrical energy storage device 3 can be that the released thermal energy can be distributed to neighboring individual cells 2 using the second law of thermodynamics. In the event of a maximum permissible operating temperature of the individual cells 2 being exceeded, neighboring individual cells 2 can react exothermically in a self-reinforced process.

Because lithium is stored in electrodes of the respective individual cell 2, volume changes arise in relation to the respective individual cell 2, wherein a cell thickness increases and in some cases decreases again. Such volume changes depend on the material and are determined by a charge level of the respective individual cell 2, and thus by a state of charge, and the changes in volume are not completely reversible.

In particular in the case of individual cells 2 having comparatively high specific energy density, combinations of carbon and silicon are partially used on an anode side. By introducing these silicon portions, greater reversible changes in volume arise when charging and discharging the respective individual cell 2. Mechanical forces thus act on a cell housing and in some circumstances on a module frame and/or a housing of the electrical energy storage device 3. If these mechanical forces exceed a certain amount, mechanical damage can arise.

Within the individual cells 2, pressure ratios caused by the volume changes also lead to disturbances, can influence an electrode structure, a stability, an electrolyte and pressure distribution, whereby an electrical capacity of the individual cells 2 can be reduced e.g., via lithium plating.

To substantially prevent a thermal runaway from spreading in a cell module of an electrical energy storage device 3, and to substantially compensate for a reversible and irreversible change in volume of the individual cells 2 during an operating duration and lifespan of the electrical energy storage device 3, a thermal barrier element 1 described in the following is provided.

Such a thermal barrier element 1, as shown in FIG. 2, is respectively arranged between two individual cells 2 of a cell module. The thermal barrier element 1 is in particular arranged between two flat sides of the respective two individual cells 2. In the context of the present invention, however, it is not required that a thermal barrier element 1 is arranged between all the individual cells 2. Instead, a thermal barrier element 1 can, e.g., also be arranged only after every second, third or nth (n=integer) individual cell 2. The thermal barrier elements 1 can also be arranged at irregular spacings after the individual cells 2. It is important that the thermal barrier elements 1 are arranged between the individual cells 2 or between groups of individual cells 2 in such a way that a thermal propagation to the point of an uncontrollable thermal runaway of the entire cell module is prevented.

In addition, a thermal barrier element 1 can respectively be arranged between a wall (not depicted in more detail) of a housing of the electrical storage device 3 and an individual cell 2 arranged on the edge of the cell module.

The thermal barrier element 1, which can also be described as a hybrid barrier, comprises a combination of materials having thermal properties and materials having endothermic properties and an at least partially flexible structure for compensating for the changes in volume.

In particular, thermal energy is absorbed via the thermal barrier element 1 via endothermic reactions in the event of a fault in an individual cell 2, wherein a thermal barrier is still present if the endothermic reactions are complete.

In the event of a thermal runaway of an individual cell 2, for example due to external influences and/or due to a singular error in the individual cell 2, the individual cell 2 is destroyed by internal exothermic reactions and releases comparatively large quantities of thermal energy. This thermal energy in the form of direct heat and heat from a combustion, e.g., of electrolyte, leads to a comparatively significant heating of the respectively neighboring individual cell 2.

Heat spreading beyond a system limit can thus lead to thermal runaway in further individual cells 2, and a spread of the thermal runaway to the entire electrical energy storage device 3 can have catastrophic consequences.

The thermal barrier element 1 respectively arranged between two individual cells 2 has a so-called sandwich structure.

The thermal barrier element 1 according to an embodiment shown in FIG. 1 comprises two compressible outer layers S1, two intermediate layers S2 and an incompressible layer S3 arranged between the intermediate layers S2.

The incompressible layer S3 comprises a grid structure and/or honeycomb structure as a support matrix. A filler is introduced into a respective chamber of the support matrix. In particular, the filler is selected such that at a certain temperature, the latter breaks down endothermically or undergoes a phase transformation, and in the event of a significant increase of a temperature, absorbs at least a part of the thermal energy.

The combination of the hydrogel, i.e., of the filler, and the support matrix as a thermal barrier or block leads to the internal temperature of neighboring individual cells 2 being effectively limited to below the critical limit temperature. Because it can be substantially prevented by means of the thermal barrier element 1 that the critical limit temperature is reached, the thermal propagation can be prevented and a fault can thus be limited to an individual cell 2 in which thermal runaway has taken place.

Usually, the released thermal energy in a thermal runaway of an individual cell 2 is significantly higher than an endothermic absorption potential of the filler, such that an energy level can only be reduced to a limited extent.

By using a so-called super-absorber as a filler of the chambers of the support matrix of the incompressible layer S3, which is soaked with water combined with ethylene, whereby a hydrogel is formed, an evaporation enthalpy of the bound water can be used. The evaporation enthalpy is higher by a multiple in comparison with other fillers e.g., salt hydrates.

The combination of the hydrogel, i.e., of the filler, and the support matrix as a thermal barrier or block leads to the internal temperature of neighboring individual cells 2 being effectively limited to below the critical limit temperature. Because it can be substantially prevented by means of the thermal barrier element 1 that the critical limit temperature is reached, the thermal propagation can be prevented and a fault can thus be limited to an individual cell 2 in which thermal runaway has taken place.

In addition, this hydrogel is protected from frost due to the composition used. An ice formation of the hydrogen at negative temperatures is thus substantially avoided.

The support matrix with the inserted filler is completely surrounded, in particular welded, by a sleeve, i.e., a pack. The sleeve is formed from polyethylene films having different thicknesses and/or from coated aluminium foils. In particular, the sleeve is designed to be impermeable to water vapour and has the function of a water vapour barrier, such that the sleeve is designed to be impermeable to gas at least for a pre-determined period of time.

For example, the sleeve can have an intended breaking point for defined opening in the event of a thermal propagation. In addition, it can be provided that the sleeve itself forms the outer layer S1 of the thermal barrier element 1 and is designed to be compressible, and thus such that it can be compressed.

An embodiment in which the sleeve of the incompressible layer S3 and the outer layers S1 form separate components is expected to be at least more cost-effective and easier to scale.

The support matrix in the form of the grid structure and/or honeycomb structure is designed to be comparatively stable. Via this stability, it is ensured that, in the event of a thermal runaway of a neighboring individual cell 2 in the respective chamber, the hydrogel located within evaporates almost entirely in all directions via a phase transition of the water stored within the hydrogel and then leaves the support matrix. A majority of the evaporation enthalpy of the filler, and thus of the hydrogel, can thus be used. A further advantage of the grid structure and/or honeycomb structure is that it still functions as a spacer and as a thermal barrier between the corresponding individual cells 2 after all of the water has evaporated. This is because, if it could be compressed, the corresponding individual cells 2 would rest on top of each other after the water has evaporated and there would be a lower thermal resistance between the two individual cells.

The compressible outer layers S1 are for example designed as tension mats. As an alternative or in addition, the outer layers S1 can also comprise other materials, e.g., foamable silicones, foamable polyurethane materials, polyurethane materials, polyethylene terephthalate fleeces, foam rubber, polyethylene foams and/or the like.

In particular, the outer layers S1 of the thermal barrier element 1 can be designed, depending on requirements, independently and without affecting a propagation protection. A minimum thickness of the propagation protection is in particular ensured by means of the incompressible layer.

Due to the sandwich structure of the thermal barrier element 1, the outer layers S1 and the incompressible layer S3 can be designed independently of each another and can then be connected to each other.

In particular, the outer layers S1 can be adhered to the sleeve of the incompressible layer S3 and/or can be materially fixed in another manner, as long as the arrangement of the intermediate layers S2 is not provided.

The outer layers S3 can be elastically deformed to compensate for the change in volume of the individual cells 2, such that a pressure acting on the neighboring individual cells 2 can be evenly distributed. A localized loading of the individual cells 2 and an accelerated ageing of the individual cells 2 caused by the latter can thus be prevented.

As described above, the thermal barrier element 1 shown in FIG. 1 comprises an intermediate layer S2 arranged in each case between an outer layer S1 and the incompressible layer S3.

These intermediate layers S2 are designed to be heat conductive to optimize a heat conduction into the incompressible layer S3. In addition, the intermediate layers S2 are provided for temperature homogenization over the neighboring surface of the individual cells 2, and thus in the plane (“in plane”) with regard to the thermal barrier element 1. Heat that is dissipated during ordinary operation or in the event of a thermal runaway of an individual cell 2 can thus be removed “in plane” in the direction of a cooling element arranged next to the cell module, e.g., a cooling plate.

For example, the intermediate layers S2 are designed as a coating of a surface of the support matrix and/or the sleeve.

In a possible embodiment, the respective intermediate layer S2 is formed from a comparatively stable material, such that the outer layers S1 can substantially be prevented from pressing into the chambers of the support matrix. For example, the intermediate layers S2 are made of glass and/or carbon fibre sheets and/or films.

The thermal barrier element 1 can be designed to be electrically insulating, e.g., to prevent short circuits between individual cells 2 between which it is arranged.

The thermal barrier element 1 as a hybrid barrier represents a solution for an electrical energy storage device 3 having more than one individual cell 2. The individual cell 2 is partially surrounded by at least one thermal barrier element 1. By means of the thermal barrier element 1, a risk of spread in the event of a thermal runaway of an individual cell 2 to neighboring individual cells 2 can be significantly reduced. In addition, a change in volume of a respective individual cell 2 in a cell module can be compensated by means of the thermal barrier element 1.

### LIST OF REFERENCE CHARACTERS

1 thermal barrier element
2 individual cell
3 electrical energy storage device
4 cell connector
S1 outer layer
S2 intermediate layer
S3 incompressible layer

1.-11. (canceled)

12. An electrical energy storage device (3), comprising:
a plurality of individual cells (2) that are electrically connected with one another in series and/or in parallel; and
a plurality of thermal barrier elements (1) that are each respectively disposed between two individual cells (2) of the plurality of individual cells (2);
wherein each of the plurality of thermal barrier elements (1) has:
one or two compressible outer layers (S1); and
an incompressible layer (S3) disposed next to the one compressible outer layer (S1) or between the two compressible outer layers (S1).

13. The electrical energy storage device (3) according to claim 12, wherein the incompressible layer (3) comprises a support matrix having a hydrogel as a filler and wherein the incompressible layer (3) is surrounded by a sleeve.

14. The electrical energy storage device (3) according to claim 13, wherein the support matrix is configured as a grid structure and/or as a honeycomb structure.

15. The electrical energy storage device (3) according to claim 13, wherein the sleeve is impermeable to gas.

16. The electrical energy storage device (3) according to claim 13, wherein the sleeve is made of polyethylene films and/or of coated aluminium foils.

17. The electrical energy storage device (3) according to claim 13, wherein the support matrix is welded into the sleeve.

18. The electrical energy storage device (3) according to claim 13, wherein the sleeve has an intended breaking point.

19. The electrical energy storage device (3) according to claim 12, wherein the respective outer layer (S1) comprises polyurethane foam which is adhered to the incompressible layer (S3).

20. The electrical energy storage device (3) according to claim 12, wherein each of the plurality of thermal barrier elements (1) has at least one heat-conductive intermediate layer (S2) which is disposed on the incompressible layer (S3).

21. The electrical energy storage device (3) according to claim 20, wherein heat is dissipatable with the at least one intermediate layer (S2) with regard to the thermal barrier element (1) in a plane in a direction of an adjacent cooling element.

22. The electrical energy storage device (3) according to claim 12, wherein the plurality of thermal barrier elements (1) are electrically insulating.
